(19) United States
(12) Patent Application Publication
(10) Pub. No.: US 2017/0108983 A1
(43) Pub. Date: Apr. 20, 2017

(54) TOUCH DISPLAY PANEL AND PIXEL STRUCTURE

(71) Applicant: Innolux Corporation, Miao-Li County (TW)

(72) Inventors: Ming-Jhih Chen, Miao-Li County (TW); Cheng-Min Wu, Miao-Li County (TW)

(73) Assignee: Innolux Corporation, Miao-Li County (TW)

(21) Appl. No.: 15/293,300

(22) Filed: Oct. 14, 2016

Related U.S. Application Data
(60) Provisional application No. 62/242,320, filed on Oct. 16, 2015.

(30) Foreign Application Priority Data
Apr. 8, 2016 (TW) 105110978

(51) Int. Cl. G06F 3/041; G06F 3/044

(52) U.S. Cl. CPC G06F 3/0416; G06F 3/0412; G06F 3/044; G06F 2203/04103; G06F 2203/04107

(57) ABSTRACT

A touch display panel includes a substrate, a sensing electrode layer, a metal layer and an active unit layer. The sensing electrode layer is disposed on the substrate and includes a plurality of sensing electrodes separated from one another and arranged in an array. The metal layer is disposed on the substrate and includes a plurality of signal lines. One signal line is used for transmitting a signal between one sensing electrode and a driving circuit. The active unit layer is disposed on the substrate and is located between the sensing electrode layer and the metal layer.

### CROSS-REFERENCE TO RELATED APPLICATION

This application claims the priority benefits of U.S. provisional application Ser. No. 62/242,320, filed on Oct. 16, 2015 and Taiwan application serial no. 105110978, filed on Apr. 8, 2016. The entirety of each of the above-mentioned patent applications is hereby incorporated by reference herein and made a part of this specification.

### BACKGROUND

1. Field of the Invention

The present disclosure relates to a display device, and more particularly to a touch display panel and touch display unit substrate.

2. Description of Related Art

Recently, kinds of electronic products are developed in a tendency of integrating their touch elements in the display panel, to reduce the space required by the keyboard or the control buttons, and the area of the screen can be arranged in a more spacious way. Therefore, the application of the touch display panel is more and more popular and wide. In general, the sensing element, such as the sensing electrode, can be equipped into the display panel, alternately, the sensing element, such as the touch panel, can be affixed to the outer side of the display panel to form the touch display panel.

The thickness of the touch display panel can be reduced and the assembly of electronic products can be more simplified by equipping the touch sensing element in the display panel. However, under the built-in design, the circuit with respect to the sensing element needs to be densely manufactured inside the display panel, which increases the required steps in the manufacturing process of the display panel and may affect the electrical property of the sensing element. For example, the coupling between the sensing element and other elements or circuits may increase the loading of the sensing element, which affects the sensing capability and the sensing quality of the sensing element. Therefore, when the sensing element is equipped inside the touch display panel, the issue about how to integrating the sensing elements in the display panel without complicating the manufacturing process and still maintaining the performance of the sensing element need to be considered.

### SUMMARY

The touch display panel of the present disclosure includes a substrate, a sensing electrode layer, a metal layer and an active unit layer. The sensing electrode layer is disposed on the substrate and includes a plurality of sensing electrodes, wherein the sensing electrodes are separated from one another and arranged in an array. The metal layer is disposed on the substrate and includes a plurality of signal lines. One of the signal lines is used for transmitting a signal between one of the sensing electrodes and a driving circuit. The active unit layer is disposed on the substrate and is located between the sensing electrode layer and the metal layer.

According to an embodiment of the present disclosure, the active unit layer includes a plurality of active units, wherein the plurality of active units is arranged in array. The metal layer further includes a plurality of shielding pads, wherein the active units overlap the shielding pads. One of the sensing electrodes overlaps N active units, wherein N is a positive integer greater than 1 and smaller than the total number of the plurality of active units. The active unit layer further includes a plurality of scanning lines and a plurality of data lines. One of the plurality of scanning lines connects one of the plurality of active units, to control the on and off of one of the plurality of active units. One of the data lines connects one of the plurality of active units. One of the active units allows the passage of the display signal of one of the plurality of data lines when one of the plurality of active units is turned on, wherein the extending direction of one of the plurality of signal lines is paralleled to the extending direction of one of the plurality of data lines.

The touch display unit substrate of the present disclosure includes a substrate, a sensing electrode, a signal line, an active unit, a scanning line and a data line. The signal line and the sensing electrode are both disposed on the substrate. The sensing electrode is electrically connected to the signal line, wherein the signal line is used for transmitting a signal between the sensing electrode and a driving circuit. The active unit is disposed between the signal line and the sensing electrode. The scanning line connects the active unit, to control the on and off of the active unit. The data line connects the active unit, wherein the active unit allows the passage of the display signal of the data line when the active unit is turned on. The extending direction of the signal line is paralleled to the extending direction of the data line.

Based on the above, in the touch display panel according to embodiments of the present disclosure, the signal line can be manufactured by materials having lower resistance. Besides, the coupling capacitance of the signal line coupled to the sensing electrode is reduced.

To make the above features and advantages of the disclosure more comprehensible, embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic top view of a touch display panel according to an embodiment of the present disclosure.

FIG. 2 is a schematic partial cross-sectional view of the touch display panel according to an embodiment of the present disclosure.

FIG. 3 is a schematic view of the active unit layer of the touch display panel according to an embodiment of the present disclosure.

FIG. 4 is a schematic view of part of the sensing electrodes and signal lines of the touch display panel according to an embodiment of the present disclosure.

FIG. 5 is a schematic view of part of the sensing electrodes and signal lines of the touch display panel according to an embodiment of the present disclosure.

FIG. 6 is a schematic top view of a touch display unit substrate according to an embodiment of the disclosure.

FIG. 7 is a schematic cross-sectional view taken along the line I-I of the touch display unit substrate in FIG. 6.

FIG. 8 is a schematic cross-sectional view taken along the line II-II of the touch display unit substrate in FIG. 6.

FIG. 9 is a schematic cross-sectional view taken along the line of the touch display unit substrate in FIG. 6.

FIG. 10 is a schematic top view of a touch display unit substrate according to another embodiment of the disclosure.

FIG. 11 is a schematic cross-sectional view taken along the line IV-IV of the touch display unit substrate in FIG. 10.

FIG. 12 is a schematic cross-sectional view taken along the line V-V of the touch display unit substrate in FIG. 10.

FIG. 13 is a schematic cross-sectional view taken along the line VI-VI of the touch display unit substrate in FIG. 10.

### DESCRIPTION OF THE EMBODIMENTS

Reference will now be made in detail to the present embodiments of the disclosure, examples of which are illustrated in the accompanying drawings. Wherever possible, the same reference numbers are used in the drawings and the description to refer to the same or like parts. In addition, the formation of a first feature connecting a second feature in the description that follows may include embodiments in which the first and second features are formed in direct contact, and may also include embodiments in which additional features may be formed between the first and second features, such that the first and second features may not be in direct contact. Alternately, the description that a first feature connects a second feature may be understood as the first feature electrically connects the second feature. Further, when one feature on a substrate is described as overlapping another feature, it may be understood that the two features are overlapped when being viewed in the direction perpendicular to the substrate plane.

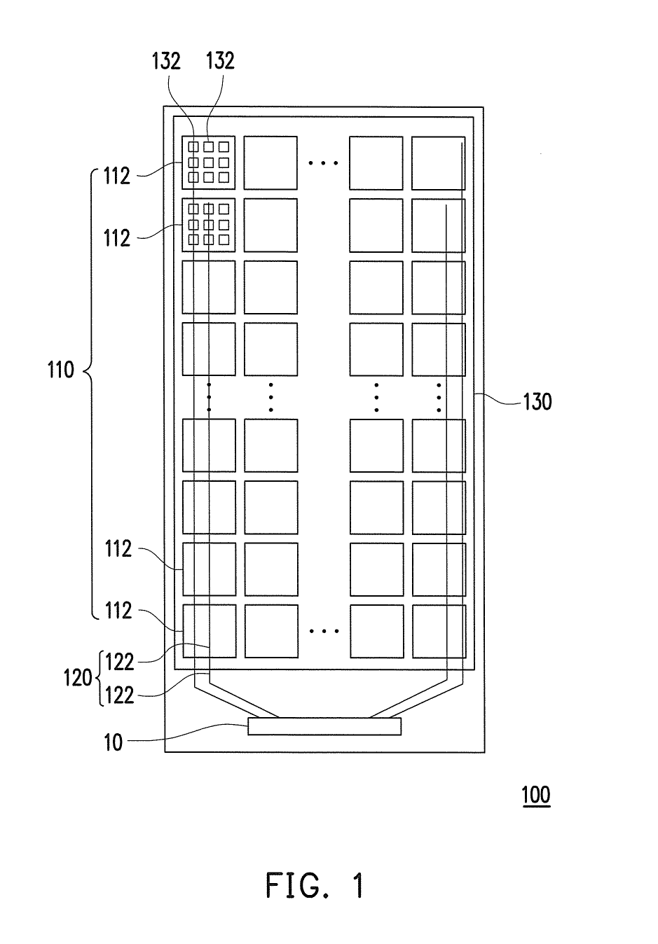

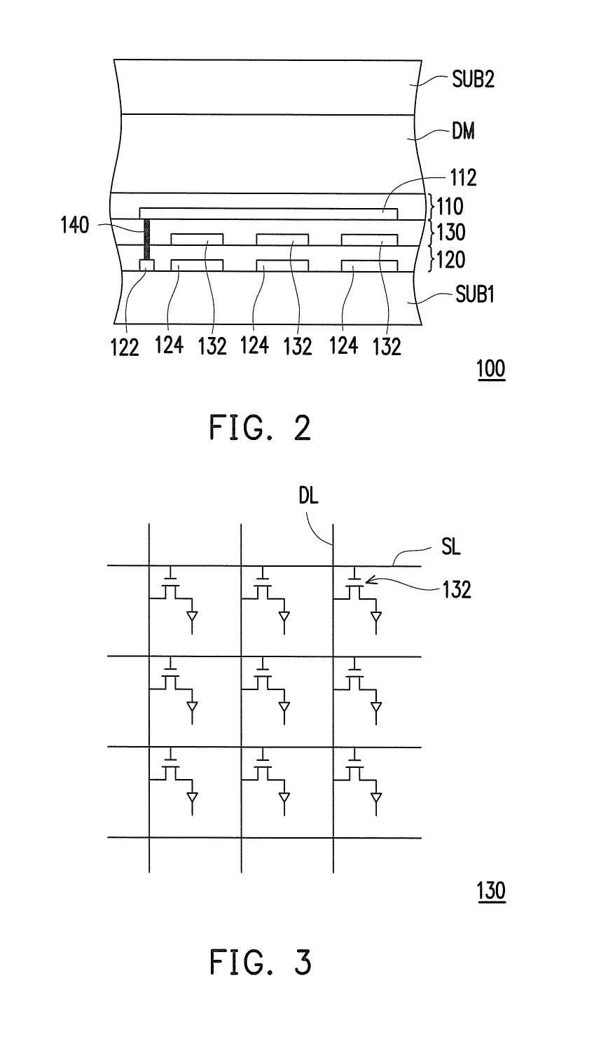

FIG. 1 is a schematic top view of a touch display panel according to an embodiment of the present disclosure, wherein FIG. 2 is a schematic partial cross-sectional view of the touch display panel according to an embodiment of the present disclosure. In FIGS. 1 and 2, the touch display panel 100 includes a substrate SUB1, a substrate SUB2, a display medium layer DM, a sensing electrode layer 110, a metal layer 120 and an active unit layer 130. The substrate SUB1 or SUB2 can be a rigid or flexible substrate. The rigid substrate is for example but not limit to glass, ceramic, or quartz. The flexible substrate is for example but not limit to plastic material such as polyimide, polyethylene terephthalate, or polycarbonate. Further, the substrate SUB1 or SUB2 can be a polarizer. The display medium layer DM is sandwiched between the substrate SUB1 and the substrate SUB2. The display medium layer DM is for example but not limit to liquid crystal layer, organic light emitting diode, micro light emitting diode, or quantum dot emitting layer. The touch display panel 100 can include other elements, such as a color filter layer and an opposite electrode layer. In addition, in order to maintain the thickness of the display medium layer DM, a support (not shown) propped between the substrate SUB1 and the substrate SUB2 can be disposed in the touch display panel 100 in some of the embodiments. Nevertheless, the disposition of these elements can be optional according to the practical requirement.

The sensing electrode layer 110 is disposed on the substrate SUB1 and includes a plurality of sensing electrodes 112. The plurality of sensing electrodes 112 are separated from one another and arranged in an array. Each sensing electrode 112 is illustrated as rectangular pattern in FIG. 1, but the shape of each sensing electrodes 112 can be adjusted according to different requirements. For example, the sensing electrodes 112 can respectively have a polygonal pattern other than a rectangular pattern, a comb-shaped pattern, etc, or each sensing electrodes 112 can have a curved outer shape. In addition, the shape and area size of the sensing electrodes 112 can be inconsistent with respect to one another.

The sensing electrodes 112 of the sensing electrode layer 110 can provide the function of touch-sensing. In particular, each sensing electrode 112 can conduct the mutual capacitance touch sensing or the self capacitance touch sensing. For the mutual capacitance touch sensing, one of two adjacent sensing electrodes 112 can be a scanning electrode and the other of the two sensing electrodes 112 can be a reading electrode. Under this circumstance, the scanning electrode is used to receive the touch scanning signals, and the reading electrode is used to readout the sensed capacitance when the corresponding scanning electrode receives the touch scanning signals. In another embodiment, the scanning electrode can be disposed outside the sensing electrode layer 110 in the touch display panel 100, and the sensing electrodes 112 of the sensing electrode layer 110 can function as the reading electrodes to accomplish the function of mutual capacitance touch sensing. In another embodiment, the reading electrode can be disposed outside the sensing electrode layer 110 in the touch display panel 100, and the sensing electrodes 112 of the sensing electrode layer 110 can function as the scanning electrodes to accomplish the function of mutual capacitance touch sensing. For the self capacitance touch sensing, the capacitance sensed by each sensing electrode 112 can be directly readout by itself to accomplish the touch sensing. In other words, the touch sensing mode of the sensing electrodes 112 of the sensing electrode layer 110 is not restricted.

In the embodiment, the display region of the touch display panel 100 is approximately wholly covered by the sensing electrodes 112 of the sensing electrode layer 110. In other embodiment, the display region is partially covered by the sensing electrodes 112. Besides, not only can the sensing electrodes 112 provide the function of touch control, the sensing electrodes 112 can also function as a common electrode, to provide the electric field to drive the display medium layer DM. In addition, the sensing electrodes 112 of the sensing electrode layer 110 can perform the functions of display and touch sensing alternately. When performing the function of display, a common potential can be inputted into the sensing electrodes 112. When performing the function of touch sensing, a touch scanning signal for touch sensing control can be inputted into the sensing electrodes 112 and then the sensing electrodes 112 can be used to read the sensed capacitance.

To accomplish the function of touch sensing, the sensing electrodes 112 need to be insulated from one another. Therefore, the shapes of the sensing electrodes 112 are separated from one another and have no substantially contact. In addition, the signals of the sensing electrodes 112 need to be transmitted independently. Therefore, the metal layer 120 is disposed on the substrate SUB1 and can include a plurality of signal lines 122, to electrically connect the sensing electrode 112 separately. In particular, one of the signal lines 122 electrically connects one of the sensing electrodes 112 and a driving circuit 10. The signal line 122 is used for transmitting a signal between one of the sensing electrodes 112 and a driving circuit 10. That is, the touch scanning signals output by the driving circuit 10 can be transmitted to the sensing electrodes 112 through one of the signal lines 122. In addition, the signals sensed by sensing electrodes 112 can be transmitted to the driving circuit 10 through one of the signal lines 122. The driving circuit 10 is disposed on the SUB1 in the embodiment. But in other embodiments, the driving circuit 10 is not disposed on the SUB1 but is disposed on another substrate, for example but not limit to a flexible printed circuit or a printed circuit board.

To transmit signals to the driving circuit 10, one end of the signal lines 122 can extends beyond the outermost sensing electrode 112. Therefore, the signal lines 122 each is only electrically connected to one of the sensing electrodes 112, but the traces of the signal line 122 can cross over the sensing electrodes 112 that are not electrically connected to the signal line 122. The coupling between the signal line 122 and the sensing electrodes 112 that are not electrically connected to the signal line 122 may cause a parasitic capacitance which increases the loading of the signal lines 122 and the sensing electrodes 112. The effect of such parasitic capacitance may affect the sensing capability and sensing sensitivity of the sensing electrodes 112.

In the embodiment, the active unit layer 130 is disposed on the substrate SUB1 and is located between the sensing electrode layer 110 and the metal layer 120. Therefore, the distance between these signal lines 122 of the metal layer 120 and these sensing electrodes 112 of the sensing electrode layer 110 is increased so as to reduce the coupling between these signal lines 122 and these sensing electrodes 112. Thus, the loading on the signal lines 122 caused by the coupling is reduced. In addition, the components of the active unit layer 130 can also provide the shielding function between the signal lines 122 of the metal layer 120 and the sensing electrodes 112 of the sensing electrode layer 110, to further reduce the loading on the signal lines 122 caused by the coupling of sensing electrodes 112. In the embodiment, because the active unit layer 130 is located between the signal lines 122 of the metal layer 120 and the sensing electrodes 112 of the sensing electrode layer 110, the touch display panel 100 can further include a plurality of connecting conductors 140, to electrically connect the sensing electrode 112 to the corresponding signal lines 122.

The active unit layer 130 includes a plurality of active units 132, and the active units 132 are arranged in array. In the embodiment, the active units 132 are located in the display region of the touch display panel 100 to function as the driving unit of the display pixel unit. Simultaneously, the sensing electrodes 112 are also disposed in the display region. One single sensing electrode 112 may overlaps N active units 132, wherein N is a positive integer greater than 1 and N is smaller than the total number of the active units 132. When the shape of the sensing electrode 112 and the active unit 132 project onto the substrate SUB1, the projection of the active unit 132 will be located in the projection of the sensing electrode 112. Furthermore, a sensing electrode 112 may overlap N display pixel units. Nevertheless, the layout resolution of the sensing electrode 112 can be adjusted according to the resolution demanded by the touch control function.

The active units 132 are normally a thin film transistor and use semiconductor material to accomplish the function of turn-on and turn-off. When most of semiconductor materials are exposed to light, a leakage current may be generated, which affects the characteristic of the active unit 132, such as the increase of the leaking current under off state. Therefore, the metal layer 120 of the touch display panel 100 further includes a plurality of shielding pads 124, wherein the active units 132 overlap the shielding pads 124 correspondingly. That is, when the shape of the shielding pads 124 project onto the substrate SUB1, the active units 132 will be located in the projection of the shielding pads 124. By the disposition of the shielding pads 124, the active units 132 can be prevented from being exposed to light. As a result, the active units 132 can have steady component characteristics.

In this embodiment, the shielding pads 124 and the signal lines 122 are manufactured with the same layer. The manufacturing of the shielding pads 124 and the signal lines 122 includes forming a metal layer on the substrate SUB1 and patterning the metal layer using a photomask to form the shielding pads 124 and the signal lines 122 simultaneously. In this way, the manufacture of the signal lines 122 needs no other metal layers, and the design of the metal layer 120 including both the signal lines 122 and shielding pads 124 would not complicate the manufacturing process of touch display panel 100. However, in other embodiment, the shielding pads 124 and the signal lines 122 are patterned through different process or photomasks. The metal layer 120 in the embodiment is closer to the substrate SUB1 compared to the active unit layer 130. In such a stacking order, the metal layer 120 is manufactured before the formation of the active unit layer 130. Therefore, the manufacturing temperature of the metal layer 120 can be higher than the withstand temperature of the composition material of the active unit layer 130. The metal layer 120 can be manufactured in a process condition with a higher temperature, so a greater chance to choosing the low-resistance material(s) can be provided. If the signal lines 122 have low resistance, the signal lines 122 can have narrower line width, making the coupling capacitance of the signal lines and other conductors lower but still maintaining a sufficient effect of signal transmission. In addition, the metal layer 120 is closer to the substrate SUB1 and there are many layers stacked on the metal layer 120, so the signal lines 122 of the metal layer 120 are relatively not easy to be scratched in the subsequent manufacturing process.

FIG. 3 is a schematic view of the active unit layer of the touch display panel according to an embodiment of the present disclosure. Referring to FIG. 3, the active unit layer 130 includes a plurality of scanning lines SL, a plurality of data lines DL, and a plurality of active units 132. One of the scanning lines SL connects multiple active units 132, to control the on (turn-on) and off (turn-off) of the active units 132. One of the data lines DL connects multiple active units 132. When the active units 132 are turned on under the control of the corresponding scanning lines SL, the active units 132 can allow the passage of the display signal of the corresponding data lines DL. When the active unit layer 130 in FIG. 3 is applied to the touch display panel 100 in FIG. 1, the extension direction of respective signal lines 122 in FIG. 1 can be configured to be paralleled to the extension direction of respective data lines DL or the extension direction of respective scanning lines SL.

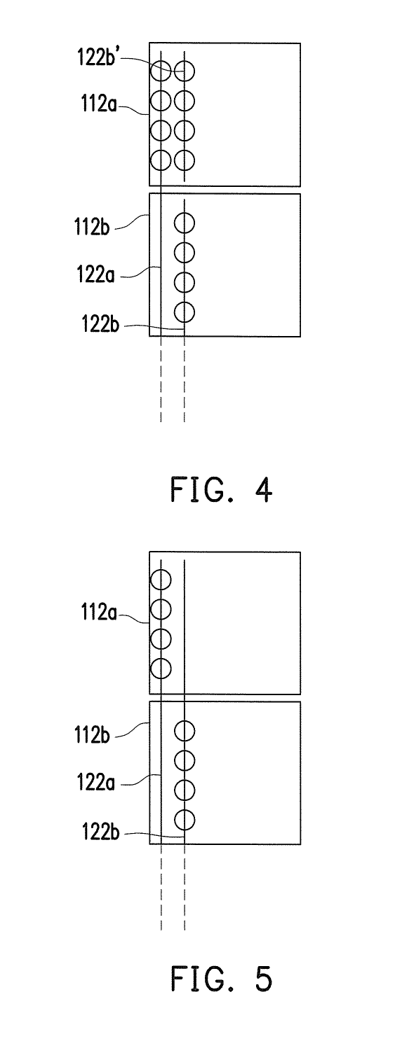

FIG. 4 is a schematic view of part of the sensing electrodes and signal lines of the touch display panel according to an embodiment of the present disclosure. According to the related description of FIG. 1, each signal line 122 is electrically connected to one of the sensing electrodes 112, but spatially, the traces of the signal lines 122 can cross over the sensing electrodes 112 that are not electrically connected to the signal lines 122. In FIG. 4, the signal line 122a is electrically connected to the sensing electrode 112a through at least one of the contact structures (four, for example, in the following embodiment, but the present disclosure is not limited thereto), and the signal line 122b is electrically connected to the sensing electrode 112b through at least one of the contact structures. The trace of the signal line 122a can extend across the sensing electrode 112b without electrically connected to the sensing electrode 112b. In other words, the trace of the signal line 122a is electrically insulated from the sensing electrode 112b. In addition, an auxiliary segment 122b′ can be disposed on the sensing electrode 112a. The auxiliary segment 122b′ is not connected to the signal line 122b and the auxiliary segment 122b′ can be electrically connected to the sensing electrode 112a. Herein, the contact structure can be a connecting channel constituted by one to several openings.

FIG. 5 is a schematic view of part of the sensing electrodes and signal lines of the touch display panel according to another embodiment of the present disclosure. In FIG. 5, the signal line 122a is electrically connected to the sensing electrode 112a through at least one of the contact structure, and the signal line 122b is electrically connected to the sensing electrode 112b through at least one of the contact structure. The trace of the signal line 122a can cross over the sensing electrode 112b without electrically connected to the sensing electrode 112b. The trace of the signal line 122b extends toward the sensing electrode 112a and the sensing electrode 112a overlaps the trace of the signal line 122b, but the signal line 122b does not electrically connect the sensing electrode 112a. As a result, the extended length of the signal line 122a and the signal line 122b can be similar.

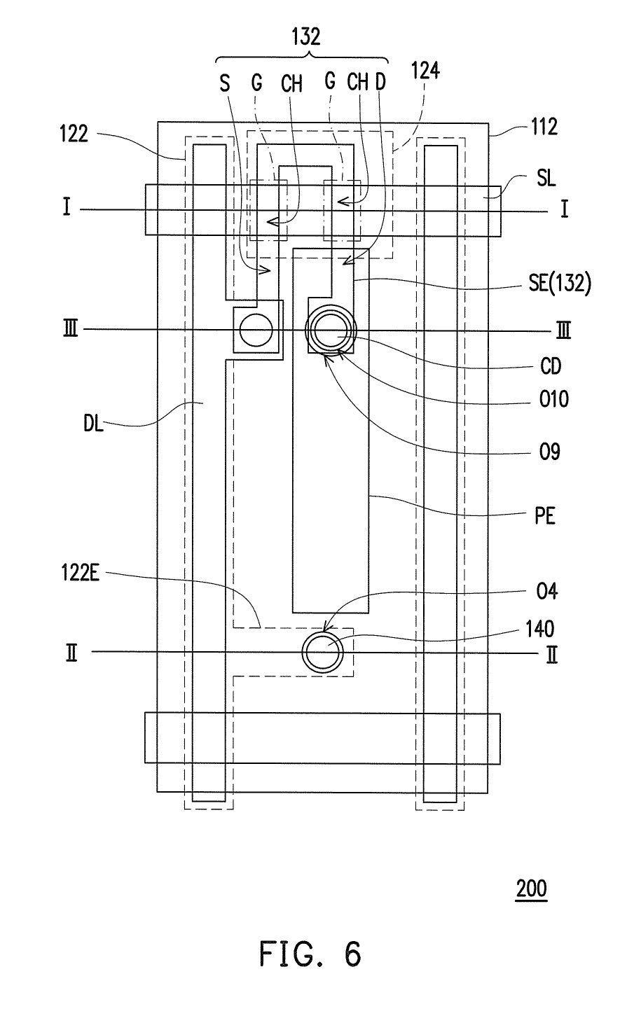

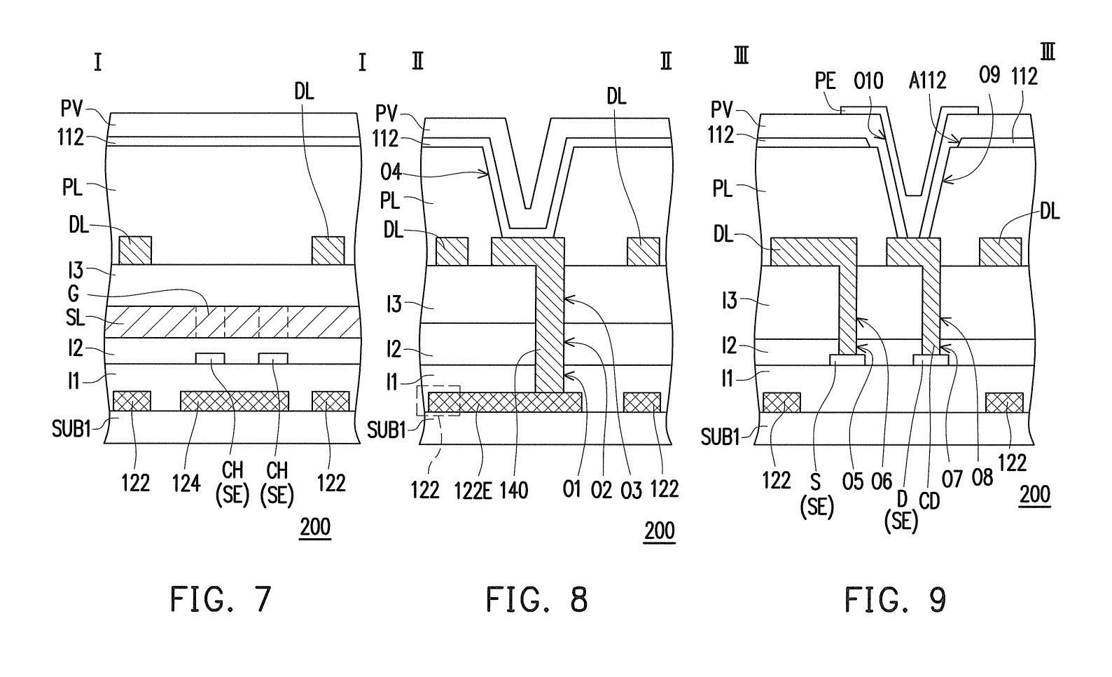

FIG. 6 is a schematic top view of a touch display unit substrate according to an embodiment of the disclosure. FIGS. 7, 8 and 9 are schematic cross-sectional views taken along the lines I-I, II-II and of the touch display unit substrate in FIG. 6. Please referring to FIGS. 6 to 9, the touch display unit substrate 200 can be applied to the touch display panel 100 of FIGS. 1 and 2 and disposed on the substrate SUB1, to drive the display medium layer DM. The touch display unit substrate 200 includes a sensing electrode 112, a signal line 122, an active unit 132, shielding pad 124, a scanning line SL and a data line DL. The layer where the signal line 122 and the shielding pad 124 are located is between the layer where the active unit 132 is located and the substrate SUB1, and the layer where the active unit 132 is located is between the layer where the sensing electrode 112 is located and the substrate SUB1. The signal line 122 is electrically connected to the sensing electrode 112, and used for transmitting a signal between the sensing electrode 112 and the driving circuit 10 depicted in FIG. 1. The active unit 132 overlaps the shielding pad 124. The scanning line SL connects the active unit 132, to control the on and off of the active unit 132. The data line connects the active unit 132. The extending direction of the signal line 122 is parallel to the extending direction of the data line DL. The data line DL overlaps the signal line 122 disposed on the substrate SUB1 of FIG. 2, for example. However, the signal line 122 has a branch 122E, and the data line DL does not overlap the branch 122E.

In addition, the touch display unit substrate 200 can further include a pixel electrode PE connected to the active unit 132, and the pixel electrode PE can overlaps the sensing electrode 112. When the active unit 132 is on, the active unit 132 allows the passage therethrough of the display signal on the data line DL to transmit the display signal to the pixel electrode PE. In the meanwhile, a common potential is input into the sensing electrodes 112, such that the potential difference between the pixel electrode PE and the sensing electrode 112 generates the driving electric field to drive the display medium layer DM depicted in FIG. 2. Therefore, the sensing electrode 112 can function as a common electrode to accomplish the display function.

In the present embodiment, the active unit 132 includes a gate G and a semiconductor layer SE, and the gate G is substantially the portion where the scanning line SL overlaps the semiconductor layer SE. The semiconductor layer SE includes a channel region CH, a source region S and a drain region D. In FIG. 6, the gate G overlaps the channel region CH, while the channel region CH is located between the source region S and the drain region D. The gate G is substantially a portion of the scanning line SL so the gate G connects the scanning line SL and is made of metal materials. The source region S connects the data line DL, and the drain region D can be electrically connected to the pixel electrode PE. In one embodiment, the active unit 132 is manufactured under a 4 masks process. Under the 4 masks process, the semiconductor layer SE, the data line DL, and the drain connection conductor CD are patterned through the same mask. The channel region CH is substantially the portion where the semiconductor layer SE not being overlapped by the data line DL and the drain connection conductor CD.

As shown in FIGS. 7 to 9, the touch display unit substrate 200 further includes a first insulating layer I1, a second insulating layer I2, a third insulating layer I3, a planarization layer PL and a passivation layer PV. The first insulating layer I1, the second insulating layer I2, the third insulating layer I3, the planarization layer PL and the passivation layer PV are made of insulating materials to isolate the conductive components of touch display unit substrate 200, so as to avoid the lack of the predetermined function of the conductive components due to short circuit.

The signal lines 122 and the shielding pad 124 are constituted by the same layer, like the metal layer 120 depicted in FIGS. 1 and 2. However, in other embodiment, the signal lines 122 and the shielding pad 124 can be constituted by different layers. The first insulating layer I1 covers the signal lines 122 and the shielding pads 124, and the semiconductor layer SE is disposed on the first insulating layer I1. The second insulating layer I2 is disposed on the first insulating layer I1, and the semiconductor layer SE is disposed between the first insulating layer I1 and the second insulating layer I2. The scanning line SL including the gate G is disposed on the second insulating layer I2. In such way, the second insulating layer I2 is disposed between the gate G and the semiconductor layer SE such that these two components have no electrically and substantially directly-contact. In the embodiment, the material of the semiconductor layer SE includes polysilicon, amorphous silicon, organic semiconductor material, oxide semiconductor material, or other materials with semiconductor properties. The active unit 132 overlaps the shielding pad 124, wherein the entirety of the channel region CH overlaps the shielding pad 124. In such way, each side of the channel region CH is shielded by the gate G and the shielding pad 124 respectively and may not be exposed to the light easily, so it can have steady characteristics.

The third insulating layer I3 is stacked on the second insulating layer I2 and covering the scanning line including the gate G, and the data line DL is disposed on the third insulating layer I3. The planarization layer PL covers the data line DL, and the sensing electrode 112 is disposed on the planarization layer PL. The passivation layer PV is disposed on the planarization layer PL. The sensing electrode 112 is disposed on the planarization layer PL, and the pixel electrode PE is disposed on the passivation layer PV. Therefore, the passivation layer PV is located between the pixel electrode PE and the sensing electrode 112.

The entirety of the active unit 132 constituted by the gate G and the semiconductor layer SE, the second insulating layer I2 between the gate G and the semiconductor layer SE, the scanning line SL, the data line DL, the third insulating layer I3 between the scanning line SL and the data line DL and the planarization layer PL covering the data line DL can be regarded as the active unit layer 130 in FIGS. 1 and 2. However, the active unit layer 130 can selectively include other components. In the present embodiment, by disposing the active unit layer 130 including multiple layers between the sensing electrode 112 and the signal lines 122, the coupling between the sensing electrode 112 and the signal lines 122 can be reduced, and the parasitic capacitance coupled between the signal line 122 and the sensing electrode 112 can be decreased. In the meanwhile, the data line DL is located between the sensing electrode 112 and the signal line 122, so the data line DL can provide the shielding effect to further prevent the sensing electrode 112 from loading increase by the parasitic capacitance between the sensing electrode 112 and signal line 122. Therefore, the sensing electrode 112 can provide excellent sensing capability or ideal sensing sensitivity when it is performing touch sensing.

For the signal line 122 electrically connected to the sensing electrode 112, as illustrated in FIG. 8, the first insulating layer I1 has a first opening O1, wherein the second insulating layer I2 has a second opening O2, the third insulating layer I3 has a third opening O3, and the first opening O1, the second opening O2 and the third opening O3 overlap the branch 122E of the signal line 122. In such a disposition of the first opening O1, the second opening O2 and the third opening O3, the branch 122E of the signal line 122 has a portion that is not covered by the first insulating layer I1, the second insulating layer I2 or the third insulating layer I3. The touch display unit substrate 200 further includes a connecting conductor 140, wherein the connecting conductor 140 passes through the first opening O1, the second opening O2 and the third opening O3 to contact the branch 122E of the signal line 122. In the meanwhile, the planarization layer PL has a fourth opening O4, so that the planarization layer PL exposes the connecting conductor 140, and the sensing electrode 112 passes through the forth opening O4 and contacts the connecting conductor 140. However, it can be known that the connecting conductor 140 passing through multiple openings to contact the branch 122E of the signal line does not necessarily require all the openings to overlap the branch 122E of the signal line. In the case of using multiple etching processes to manufacture different openings, such openings may partially overlap or not overlap the branch 122E of the signal line at all.

As illustrated in FIG. 9, for the data line DL electrically connected to the source region S of the semiconductor layer SE, the second insulating layer I2 has a fifth opening O5, wherein the third insulating layer I3 has a sixth opening O6, the second insulating layer I2 and the third insulating layer I3 both expose the source region S by the fifth opening O5 and the sixth opening O6, and the data line DL contacts the source region S through the fifth opening O5 and the sixth opening O6.

In addition, for the pixel electrode PE electrically connected to the drain region D, the second insulating layer I2 has a seventh opening O7, wherein the third insulating layer I3 has a eighth opening O8, and the second insulating layer I2 and the third insulating layer I3 both expose the drain region D by the seventh opening O7 and the eighth opening O8. The touch display unit substrate 200 further includes a drain connection conductor CD, and the drain connection conductor CD contacts the drain region D through the seventh opening O7 and the eighth opening O8. In addition, the planarization layer PL has a ninth opening O9, wherein the passivation layer PV has a tenth opening O10, the planarization layer PL and the passivation layer PV both expose the drain connection conductor CD by the ninth opening O9 and the tenth opening O10, and the pixel electrode PE contacts the drain connection conductor CD through the ninth opening O9 and the tenth opening O10. Under this circumstance, the sensing electrodes 112 has an electrode opening A112, wherein the area of the ninth opening O9 and the tenth opening O10 are located in the area of the electrode opening A112, to prevent the sensing electrode 112 from electrically connecting the pixel electrode PE directly.

In the embodiment, the first opening O1, the second opening O2, the third opening O3, the fifth opening O5, the sixth opening O6, the seventh opening O7 and the eighth opening O8 can be formed by performing the same patterning step before the manufacture of data line DL, connecting conductor 140 and the drain connection conductor CD, but the disclosure is not limited thereto. For example, in the feasible embodiments, different openings can be formed by performing multiple patterning steps. In addition, the data line DL, the connecting conductor 140 and the drain connection conductor CD can be obtained by patterning the same metal layer. Furthermore, the forth opening O4 and the ninth opening O9 can be formed by the same patterning step. In such way, although there are many layers interposed between the sensing electrode 112 and the signal line 122, the opening disposed for accomplishing the electrical connection between these two components needs no independent manufacturing steps. Therefore, the touch display unit substrate 200 can be manufactured by the existing process.

In the embodiment, the material of the first insulating layer I1, the second insulating layer I2, the third insulating layer I3 and the passivation layer PV may be silicon oxide, silicon nitride, silicon oxynitride or other insulating material. The material of the planarization layer PL may be organic insulating material or other insulating materials capable of having sufficient layer thickness. The thickness of the planarization layer PL can be greater than the thickness of the first insulating layer I1, the second insulating layer I2, the third insulating layer I3 and the passivation layer PV, to provide an ideal planarization effect.

The signal line 122 is finished before the manufacture of the planarization layer PL. The signal line 122, the active unit 132, the scanning line SL and the data line DL are covered by the planarization layer PL. The height difference caused by the signal line 122, the active unit 132, the scanning line SL and the data line DL in the stacking direction of the layers can be mitigated through the planarization layer PL. This can help to enhance the manufacture yield of the touch display panel including the touch display unit substrate 200. In the case the touch display unit substrate 200 is applied to the touch display panel 100 in FIG. 2, the touch display panel 100 normally needs a support (not shown) propped between the substrate SUB1 and the substrate SUB2 to maintain the thickness of the display medium layer DM. In the meanwhile, the better the planarization effect of the planarization layer PL, the more steadily the support propped between the substrate SUB1 and the substrate SUB2. In addition, an alignment layer (not shown) may be disposed on the side where the touch display unit substrate 200 faces the display medium layer DM. For example, the alignment layer is disposed on the pixel electrode PE. The alignment layer is used to control the arrangement of the display medium material in the display medium layer DM, such as the liquid crystal material. The alignment effect of the alignment layer can be accomplished by performing a rubbing process. When the flatness of the planarization layer PL is poor, the rubbing force applied onto the surface of the alignment layer and the rubbing direction of the alignment layer may not be uniformly controlled, which cause a poor alignment effect. As a result, with a better the planarization effect of the planarization layer PL, the yield of the touch display panel 100 can be ensured.

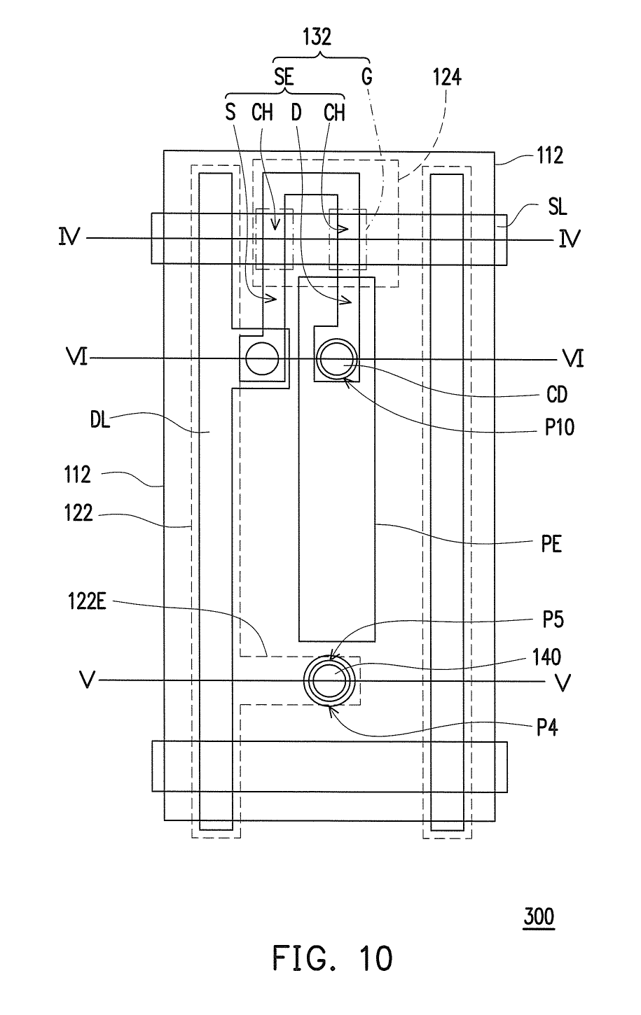

FIG. 10 is a schematic top view of a touch display unit substrate according to another embodiment of the disclosure. FIGS. 11, 12 and 13 are schematic cross-sectional views taken along lines IV-IV, V-V and VI-VI of the touch display unit substrate in FIG. 10. Please referring to FIGS. 10 to 13, the touch display unit substrate 300 can be applied to the touch display panel 100 of FIGS. 1 and 2, to drive the display medium layer DM. The touch display unit substrate 300 includes the sensing electrode 112, the signal line 122, the active unit 132, the shielding pad 124, the scanning line SL and the data line DL as depicted in FIGS. 1 and 2. The signal line 122 is electrically connected to the sensing electrode 112, wherein the signal line 122 is used for transmitting a signal between the sensing electrode 112 and the driving circuit 10 shown in FIG. 1. The scanning line SL controls the on and off of the active unit 132. The data line DL connects the active unit 132. The extending direction of the signal line 122 is parallel to the extending direction of the data line DL. The area of data line DL overlaps the signal line 122. However, the signal line 122 has a branch 122E, and the data line DL does not overlap the branch 122E. The area of the active unit 132 overlaps the shielding pad 124. In addition, the touch display unit substrate 300 can further include a pixel electrode PE connected to the active unit 132. The electrical connection relationship of the components in the touch display unit substrate 300 is approximately identical to the touch display unit substrate 200, so the components of the active unit 132 and the connection relationship between the active unit 132 and the pixel electrode PE can be referred to the related description of the touch display unit substrate 200, the description is omitted herein. However, the stacking order of the sensing electrode 112 and pixel electrode PE of the touch display unit substrate 300 are different from the touch display unit substrate 200.

As illustrated in FIGS. 11 to 13, the touch display unit substrate 300 further includes a first insulating layer I1, a second insulating layer I2, a third insulating layer I3, a planarization layer PL and a passivation layer PV. The stacking order of the first insulating layer I1, the second insulating layer I2, the third insulating layer I3, the planarization layer PL and the passivation layer PV is approximately identical to the touch display unit substrate 200. However, in the embodiment, the pixel electrode PE is disposed on the planarization layer PL. The passivation layer PV is disposed on the pixel electrode PE, and the sensing electrode 112 is disposed on the passivation layer PV, so the pixel electrode PE is located between the passivation layer PV and the planarization layer PL. In the embodiment, the sensing electrode 112 includes a plurality of slits (not shown). Thus, the electric field between the sensing electrode 112 and the pixel electrode PE can apply to the display medium layer DM. In the embodiment, the first insulating layer I1, the second insulating layer I2, the third insulating layer I3, the planarization layer PL, the active unit 132, the scanning line SL and the data line DL can constitute the active unit layer 130 of FIGS. 1 and 2. However, the active unit layer 130 can selectively include other components.

In the embodiment, at least the first insulating layer I1, the second insulating layer I2, the third insulating layer I3, the planarization layer PL, the passivation layer PV, the active unit 132, the scanning line SL and the data line DL are interposed between the layers where the sensing electrode 112 and the signal line 122 are located, which helps to reduce the coupling between the sensing electrode 112 and the signal line 122, so as to reduce the parasitic capacitance between the sensing electrode 112 and the signal line 122. In the meanwhile, the data line DL is located between the sensing electrode 112 and the signal line 122, so the data line DL can provide a further shielding effect to prevent the signal line 122 and the sensing electrode 112 from the increase of loading caused by the coupling between the sensing electrode 112 and the signal line 122. Therefore, the sensing electrode 112 can provide good touch sensing ability when performing touch sensing.

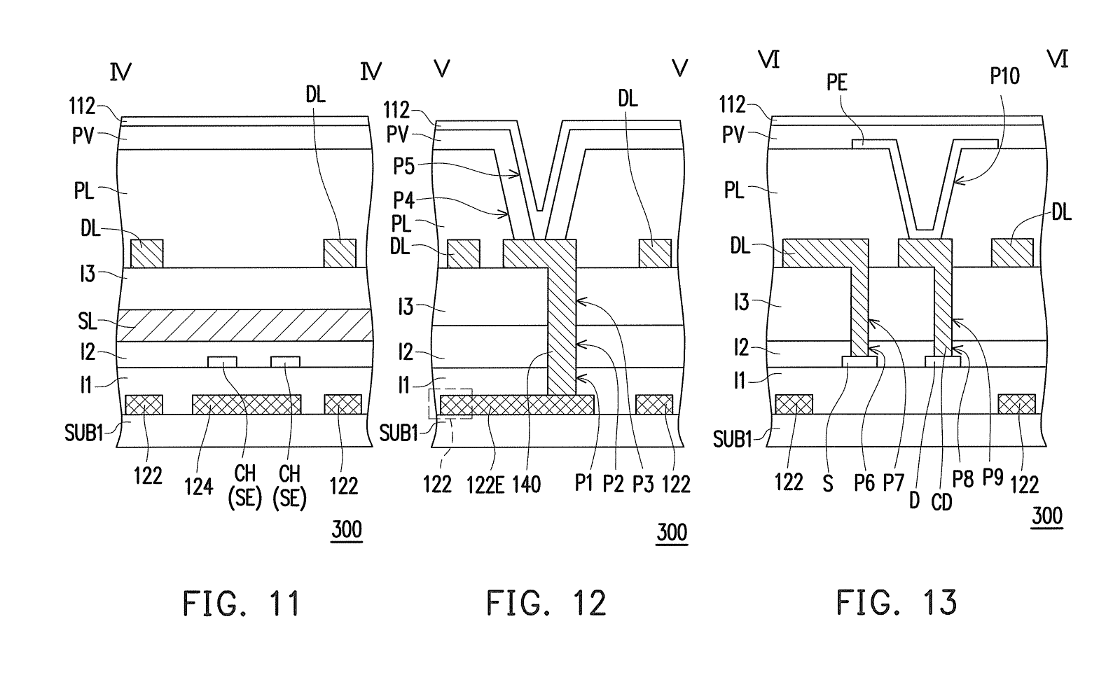

For the signal line 122 electrically connected to the sensing electrode 112, as illustrated in FIG. 12, the first insulating layer I1 has a first opening P1, wherein the second insulating layer I2 has a second opening P2, the third insulating layer I3 has a third opening P3, and the first insulating layer I1, the second insulating layer I2 and the third insulating layer I3 expose the branch 122E of the signal line 122 via the first opening P1, the second opening P2 and the third opening P3. The touch display unit substrate 300 further includes a connecting conductor 140, and the connecting conductor 140 passes through the first opening P1, the second opening P2 and the third opening P3 and contacts the branch 122E of the signal line 122. In the meanwhile, the planarization layer PL has a fourth opening P4 and the passivation layer PV has a fifth opening P5, wherein the planarization layer PL and the passivation layer PV both expose the connecting conductor 140 via the forth opening P4 and the fifth opening P5, and the sensing electrode 112 passes through the forth opening P4 and the fifth opening P5 to contact the connecting conductor 140. However, it is noted that the connecting conductor 140 passing through multiple openings to contact the branch 122E of the signal line 122 does not necessarily require all the openings to expose the branch 122E of the signal line 122. In the case of using multiple etching processes to fabricate different openings, such openings may partially expose or not at all expose the branch 122E of the signal line.

As illustrated in FIG. 13, for the data line DL electrically connected to the source region S of the semiconductor layer SE, the second insulating layer I2 has a sixth opening P6, wherein the third insulating layer I3 has a seventh opening P7, the second insulating layer I2 and the third insulating layer I3 both expose the source region S via the sixth opening P6 and the seventh opening P7, and the data line DL contacts the source region S through the sixth opening P6 and the seventh opening P7.

In addition, for the pixel electrode PE electrically connected to the drain region D, the second insulating layer I2 has an eighth opening P8, the third insulating layer I3 has a ninth opening P9, and the second insulating layer I2 and the third insulating layer I3 both expose the drain region D via the eighth opening P8 and the ninth opening P9. Also, the touch display unit substrate 300 further includes a drain connection conductor CD, and the drain connection conductor CD contacts the drain region D through the eighth opening P8 and the ninth opening P9. In addition, the planarization layer PL has a tenth opening P10, wherein the planarization layer PL expose the drain connection conductor CD via the tenth opening P10, and the pixel electrode PE contacts the drain connection conductor CD through the tenth opening P10.

In the embodiment, the data line DL, the connecting conductor 140 and the drain connection conductor CD can be formed by patterning the same layer. The first opening P1, the second opening P2, the third opening P3, the sixth opening P6, the seventh opening P7, the eighth opening P8 and the ninth opening P9 can be manufactured by the patterning steps before the manufacture of the data line DL, the connecting conductor 140 and the drain connection conductor CD. Furthermore, the forth opening P4 and the tenth opening P10 can be made by the same patterning step. Although there are many layers interposed between the sensing electrode 112 and the signal line 122, the openings disposed for accomplishing the electrical connection between two components needs no independent manufacturing steps to be manufactured. Therefore, the touch display unit substrate 300 can be formed by the existing process. In addition, the touch display unit substrate 300 and the touch display unit substrate 200 described previously can both provide planarization effect by using planarization layer PL, so the touch display panel including the touch display unit substrate 300 can have ideal quality or yield.

In summary, in the touch display panel and touch display unit substrate according to the embodiments of the present disclosure, an active unit layer is interposed between the sensing electrode and the signal line transmitting the signal of the sensing electrode, and the active unit layer is constituted by multiple layers. Therefore, the coupling between the sensing electrode and the signal layer can be significantly reduced, which helps to reduce the loading of the signal line and the sensing electrode caused by the parasitic capacitance on the sensing electrode. Also, the scanning line or the data line can overlap the signal line of the embodiment of the present disclosure, so the scanning line or the data line can be used as the shield between the signal line and the sensing electrode, so as to further reduce the possible parasitic capacitance on the sensing electrode caused by the signal line. In such way, the sensing electrode can provide ideal touch control ability. In addition, because the signal line is manufactured by the metal layer, the planarization layer can cover the signal line and the components of the active unit layer, such that the planarization layer can have planarization effect to enhance the quality or the yield of the touch display panel.

Even though the disclosure is disclosed through the embodiments as above, the embodiments are not used to limit this disclosure, and any person with ordinary skill in the art, without deviating from the teachings and scope of this disclosure, may make adjustments and refinements; therefore, the scope of protection of this patent is defined as following claims.

What is claimed is:

1. A touch display panel, comprising:
a substrate;
a sensing electrode layer, disposed on the substrate and comprising a plurality of sensing electrodes, wherein the plurality of sensing electrodes are separated from one another;
a metal layer, disposed on the substrate and comprising a plurality of signal lines, wherein one of the signal lines connects one of the sensing electrodes and a driving circuit; and
an active unit layer, disposed on the substrate and located between the sensing electrode layer and the metal layer.

2. The touch display panel according to claim 1, wherein the active unit layer comprises a plurality of active units and the plurality of active units are arranged in an array.

3. The touch display panel according to claim 2, wherein the metal layer further comprises a plurality of shielding pads, and the plurality of active units overlap the plurality of shielding pads.

4. The touch display panel according to claim 2, wherein the one of the plurality of sensing electrodes overlaps N active units of the plurality of active units, N is a positive integer greater than 1 and N is smaller than a total number of the plurality of active units.

5. The touch display panel according to claim 2, wherein the active unit layer further comprises:
a plurality of scanning lines, wherein one of the plurality of scanning lines connects one of the plurality of active units; and
a plurality of data lines, wherein one of the plurality of data lines connects one of the plurality of active units, and an extending direction of one of the plurality of signal lines is parallel to an extending direction of one of the plurality of data lines.

6. The touch display panel according to claim 1, further comprising a plurality of connecting conductors, one of the plurality of connecting conductors connects the one of the plurality of signal lines to the one of the plurality of sensing electrodes.

7. The touch display panel according to claim 1, wherein one end of the one of the plurality of signal lines extends beyond an outermost one of the plurality of sensing electrodes.

8. The touch display panel according to claim 1, further comprising a display medium layer disposed on the sensing electrode layer.

9. A touch display unit substrate, comprising:
a substrate;
a signal line, located on the substrate;
a sensing electrode, located on the signal line, wherein the sensing electrode connects the signal line;
an active unit, located between the signal line and the sensing electrode;
a scanning line, connecting the active unit; and
a data line, connecting the active unit, wherein an extending direction of the signal line is parallel to an extending direction of the data line.

10. The touch display unit substrate according to claim 9, wherein the data line overlaps the signal line.

11. The touch display unit substrate according to claim 10, wherein the signal line has a branch, and the branch connects the sensing electrode.

12. The touch display unit substrate according to claim 9, further comprising a shielding pad overlapping the active unit.

13. The touch display unit substrate according to claim 12, wherein the shielding pad and the signal line are constituted by the same layer.

14. The touch display unit substrate according to claim 9, wherein the active unit comprises a gate and a semiconductor layer, the semiconductor layer comprises a channel region, a source region and a drain region, the gate overlaps the channel region, the channel region is located between the source region and the drain region, the gate is connected to the scanning line and the source region is connected to the data line.

15. The touch display unit substrate according to claim 14, further comprising:
a first insulating layer, covering the signal line, wherein the semiconductor layer is disposed on the first insulating layer;
a second insulating layer, disposed between the semiconductor layer and the gate;
a third insulating layer, covering the gate, wherein the data line is disposed on the third insulating layer;
a planarization layer, covering the data line, wherein the sensing electrode is disposed on the planarization layer;
a passivation layer, disposed on the planarization layer; and
a pixel electrode, wherein the passivation layer is located between the pixel electrode and the sensing electrode.

16. The touch display unit substrate according to claim 15, further comprising a connecting conductor, wherein the first insulating layer has a first opening, the second insulating layer has a second opening, the third insulating layer has a third opening, and the connecting conductor passes through the first opening, the second opening and the third opening and connects the signal line.

17. The touch display unit substrate according to claim 16, wherein the planarization layer has a fourth opening, and the sensing electrode passes through the fourth opening and connects the connecting conductor.

18. The touch display unit substrate according to claim 17, wherein the passivation layer has a fifth opening, and the sensing electrode passes through the forth opening and the fifth opening and connects the connecting conductor.

19. The touch display unit substrate according to claim 15, wherein the pixel electrode is located between the passivation layer and the planarization layer.

20. The touch display unit substrate according to claim 15, wherein the sensing electrode is located between the passivation layer and the planarization layer.
